(19) United States
(12) Patent Application Publication
(10) Pub. No.: US 2005/0135358 A1
(43) Pub. Date: Jun. 23, 2005

(54) Method and system for pre-fetching network data using a pre-fetching control protocol

(76) Inventor: Pravin D. Mane, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,788

(22) Filed: Dec. 23, 2003

(51) Int. Cl. H04L 12/56

(52) U.S. Cl. 370/389

(57) ABSTRACT

A method and system for pre-fetching network data using a pre-fetching control protocol is described. The method includes dividing a data transmission into a plurality of packets at a source, transmitting a number of the packets of the data transmission from the source to a destination while transmitting the remaining packets of the data transmission from the source to an alternate node, and transmitting to the destination the packets received at the alternate node from the source. The packets of the data transmission received from the source and the alternate node may then be assembled and reordered at the destination.

### BACKGROUND

1. Technical Field

Embodiments of the invention relate to the field of network data processing, and more specifically to a system and method for pre-fetching network data using a pre-fetching control protocol.

2. Background Information and Description of Related Art

Delay in receiving network data is undesirable in many situations, especially with applications that have real-time requirements, such as streaming media applications. One requirement for these applications is that data packets need to be delivered in time for the destination host to use the data in the packet. In the case of a video or audio transfer, if data is not delivered on time, then the user may experience choppy video or audio feed, or jittery frames on the screen. At the destination, most late arriving audio or video packets are discarded, since it is useless to display a late frame in continuous media applications with strict real time requirements.

This problem of late arriving data is even more pronounced in wireless networks. To transfer various types of application level data on the internet, two transport level protocols are predominantly used, Transmission Control Protocol (TCP) and User Datagram Protocol (UDP). TCP is tuned for traditional networks made of wired links and stationary hosts. In wired networks, there are relatively low bit error rates, so packet losses are assumed to be due to congestion. Therefore, TCP reacts to packet losses by reducing the transmission window before retransmitting the lost packets. However, wireless links have relatively high bit error rates, higher delays and occasional blackouts. Therefore, the reduction of the transmission window by TCP in reaction to packet losses causes poor bandwidth utilization, poor throughput, and high delays in wireless networks.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is a flow diagram illustrating a method according to an embodiment of the invention.

FIG. 3 is a block diagram illustrating a suitable computing environment in which certain aspects of the illustrated invention may be practiced.

### DETAILED DESCRIPTION

Embodiments of a system and method for pre-fetching network data using a pre-fetching control protocol are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

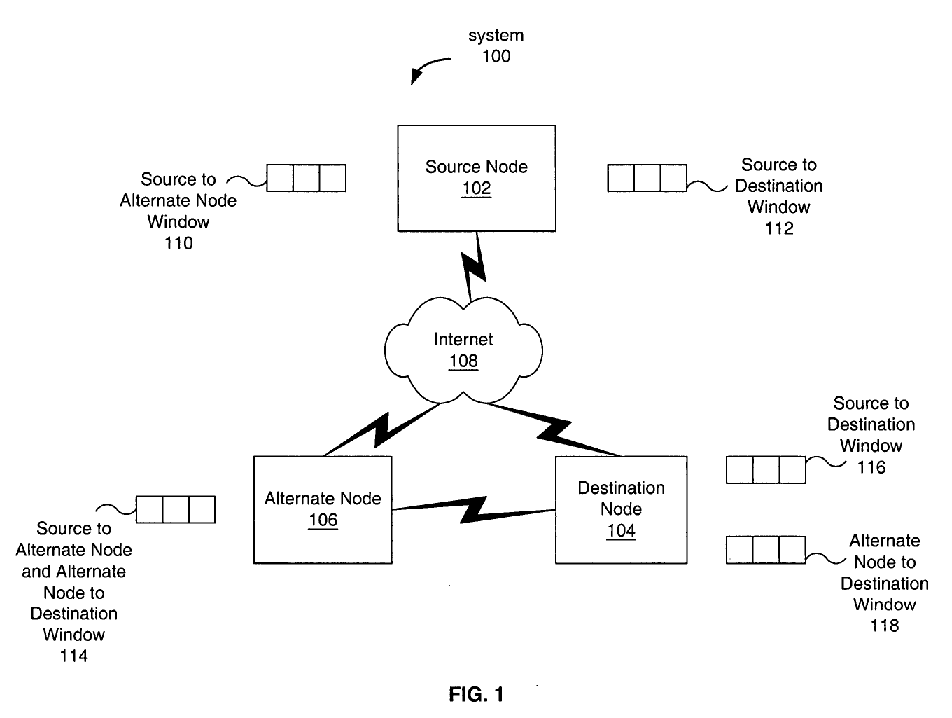

Referring to FIG. 1, a block diagram illustrates a system 100 according to one embodiment of the invention. Those of ordinary skill in the art will appreciate that the system 100 may include more components than those shown in FIG. 1. For example, there may be one or more intermediate nodes between the nodes shown. However, it is not necessary that all of these generally conventional components be shown in order to disclose an illustrative embodiment for practicing the invention.

System 100 includes a source node 102, a destination node 104, and an alternate node 106, connected to each other via communication links. A data transmission to be transmitted from the source 102 to the destination 104 is divided into a plurality of packets or octets. Different paths from the source 102 to the destination 104 are determined. One of these paths is chosen for the direct transmission of data from the source 102 to the destination 104. In one embodiment, a node on one of the other paths is chosen as an alternate transmission node 106. The alternate node 106 may also be chosen to lie on the same path as the path chosen for the transmission from the source to the destination; however, this choice may not have the advantage of load balancing traffic in the network.

The alternate node 106 may be one of a number of different devices, including but not limited to a desktop computer connected to the Internet, an access point in a wireless network, or a mobile device, such as a laptop or a personal digital assistant (PDA). Various factors may be used to choose the alternate node 106, such as the location of the node, power requirements or power availability at the node, buffer availability at the node, and security concerns.

A number of the packets of the data transmission are transmitted directly from the source 102 to the destination 104 via the chosen path. The remaining packets of the data transmission are transmitted from the source 102 to the chosen alternate node 106. The packets received at the alternate node 106 from the source 102 are then transmitted to the destination 104. The packets of the data transmission received from the source and the alternate node are assembled and reordered at the destination 104.

The division of data between the destination and alternate nodes can be determined in various ways. For example, in one embodiment, alternating packets of the data transmission may be transmitted from the source node to the destination and alternate nodes (i.e., the first packet of the data transmission is transmitted directly to the destination from the source, the second packet of the data transmission is transmitted from the source to the alternate node, the third packet of the data transmission is transmitted directly to the destination, the fourth packet of the data transmission is transmitted to the alternate node, and so on). In an alternative embodiment, the division of data may be based on the type of data transmitted. For instance, multimedia transmissions that include Forward Error Correction (FEC) data packets may be divided so that the extra FEC data packets are transmitted to the alternate node while the remaining data packets of the multimedia transmission are transmitted directly to the destination. Various other schemes of dividing the data transmitted to the destination and alternate nodes may be implemented.

In one embodiment, system 100 uses a sliding window protocol for the data transmissions known as the pre-fetch control protocol (PCP). The PCP protocol is similar to the sliding window protocol used by the Transmission Control Protocol (TCP), except that multiple sliding windows may be used for data transmission at each of the nodes. At the source node 102, two sliding windows 110 and 112 are used for data transmissions. Sliding window 112 is used for the transmission of packets from the source node 102 to the destination node 104, while sliding window 110 is used for the transmission of packets from the source node 102 to the alternate node 106. At the destination node 106, two sliding windows 116 and 118 are used for data transmissions. The sliding window 116 is used for the transmission of packets from the source node 102 to the destination node 104, while sliding window 118 is used for the transmission of packets from the alternate node 106 to the destination node 104.

In one embodiment, the alternate node uses two sliding windows for data transmissions: one window for the transmission of packets from the source node 102 to the alternate node 106 and one window for the transmission of packets from the alternate node 106 to the destination node 104. In an alternative embodiment, as shown in FIG. 1, the alternate node may use one sliding window for both the transmission of packets from the source node 102 to the alternate node 106 and the transmission of packets from the alternate node 106 to the destination node 104. In this embodiment, when the sliding window is full from data transmitted from the source 102, the alternate node 102 will stop accepting data from the source 102 until some of the data has been transmitted to the destination 104.

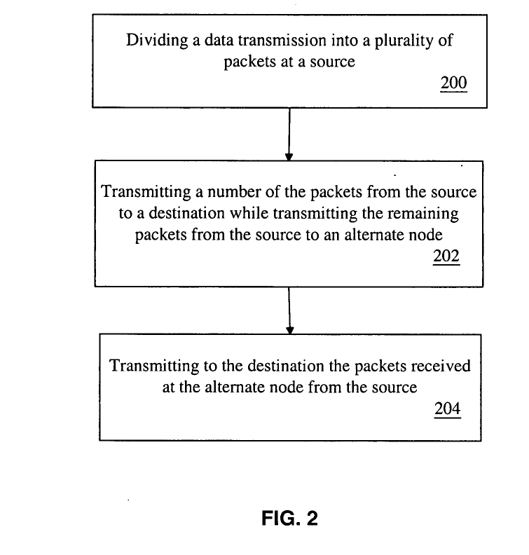

FIG. 2 illustrates a method according to one embodiment of the invention. At 200, a data transmission is divided into a plurality of packets at a source. At 202, a number of the plurality of packets is transmitted from the source to a destination while the remaining packets of the data transmission are transmitted from the source to an alternate node. In one embodiment, a number of the packets are transmitted from the source to the destination via one path while the remaining packets are transmitted from the source to the alternate node via another path. In one embodiment, alternating packets of the data transmission are transmitted from the source to the destination and the alternate node. In one embodiment, two transmission windows are opened at the source: one window for the transmission to the destination and another window for the transmission to the alternate node. In one embodiment, two transmission windows are opened at the destination: one window for the transmission from the source and another window for the transmission from the alternate node. In one embodiment, two transmission windows are opened at the alternate node: one window for the transmission from the source and another window for the transmission to the destination. In one embodiment, one transmission window is opened at the alternate node, which is used for both the transmission from the source and the transmission to the destination. At 204, the packets received at the alternate node from the source are transmitted to the destination. In one embodiment, the packets of the data transmission are assembled and reordered at the destination.

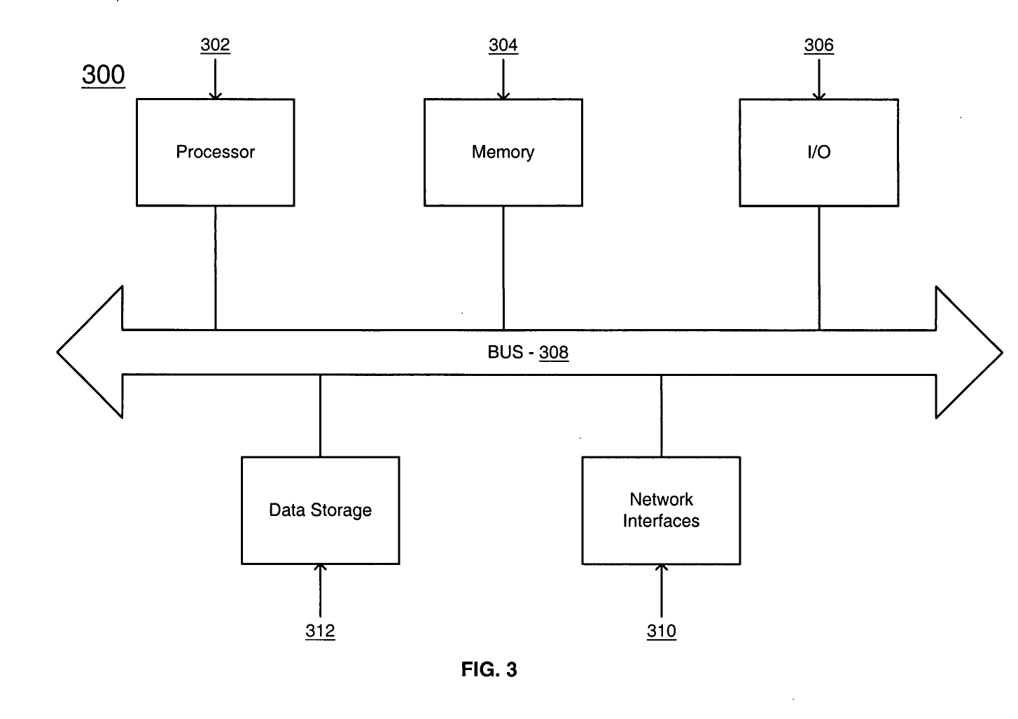

FIG. 3 is a block diagram illustrating a suitable computing environment in which certain aspects of the illustrated invention may be practiced. In one embodiment, the method described above may be implemented on a computer system 300 having components 302-312, including a processor 302, a memory 304, an Input/Output device 306, a data storage device 312, and a network interface 310, coupled to each other via a bus 308. The components perform their conventional functions known in the art and provide the means for implementing the system 100. Collectively, these components represent a broad category of hardware systems, including but not limited to general purpose computer systems and specialized packet forwarding devices. It is to be appreciated that various components of computer system 300 may be rearranged, and that certain implementations of the present invention may not require nor include all of the above components. Furthermore, additional components may be included in system 300, such as additional processors (e.g., a digital signal processor), storage devices, memories, and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
dividing a data transmission into a plurality of packets at a source;
transmitting a number of the plurality of packets from the source to a destination while transmitting the remaining packets of the data transmission from the source to an alternate node; and
transmitting to the destination the packets received at the alternate node from the source.

2. The method of claim 1, further comprising assembling and reordering the packets of the data transmission at the destination.

3. The method of claim 1, wherein transmitting a number of the packets from the source to a destination while transmitting the remaining packets from the source to an alternate node comprises transmitting a number of the packets from the source to the destination via one path while transmitting the remaining packets from the source to the alternate node via an alternate path.

4. The method of claim 1, wherein transmitting a number of the packets from the source to a destination while transmitting the remaining packets from the source to an alternate node comprises transmitting from the source alternating packets of the data transmission to the destination and the alternate node.

5. The method of claim 1, wherein transmitting a number of the packets from the source to a destination while transmitting the remaining packets from the source to an alternate node comprises opening two transmission windows at the source.

6. The method of claim 5, wherein opening two transmission windows at the source comprises opening a first Pre-fetch Control Protocol (PCP) window for the transmission to the destination and opening a second PCP window for the transmission to the alternate node.

7. The method of claim 1, wherein transmitting a number of the packets from the source to a destination while transmitting the remaining packets from the source to an alternate node comprises opening two transmission windows at the alternate node, one window for the transmission from the source and another window for the transmission to the destination.

8. The method of claim 1, wherein transmitting a number of the packets from the source to a destination while transmitting the remaining packets from the source to an alternate node comprises opening one transmission window at the alternate node to be used for the transmission from the source and the transmission to the destination.

9. The method of claim 1, transmitting a number of the packets from the source to a destination while transmitting the remaining packets from the source to an alternate node comprises opening two transmission windows at the destination, one window for the transmission from the source and another window for the transmission from the alternate node.

10. An article of manufacture comprising:
a machine accessible medium including content that when accessed by a machine causes the machine to perform operations comprising:
determining a first path and an alternate path for data transmission from a source to a destination;
selecting an alternate node located on the alternate path to receive data transmissions from the source and transmit data to the destination;
transmitting a number of packets of a data transmission from the source to the destination via the first path while transmitting the remaining packets of the data transmission from the source to the alternate node via the alternate path; and
transmitting to the destination the packets received at the alternate node from the source.

11. The article of manufacture of claim 10, wherein the machine-accessible medium further includes content that causes the machine to perform operations comprising assembling and reordering the packets of the data transmission at the destination.

12. The article of manufacture of claim 10, wherein the machine accessible medium including content that when accessed by the machine causes the machine to perform operations comprising transmitting a number of packets of a data transmission from the source to the destination via the first path while transmitting the remaining packets of the data transmission from the source to the alternate node via the alternate path comprises the machine accessible medium including content that when accessed by the machine causes the machine to perform operations comprising transmitting from the source alternating packets of the data transmission to the destination and the alternate node.

13. The article of manufacture of claim 10, wherein the machine accessible medium including content that when accessed by the machine causes the machine to perform operations comprising transmitting a number of packets of a data transmission from the source to the destination via the first path while transmitting the remaining packets of the data transmission from the source to the alternate node via the alternate path comprises the machine accessible medium including content that when accessed by the machine causes the machine to perform operations comprising opening two transmission windows at the source.

14. The article of manufacture of claim 13, wherein the machine accessible medium including content that when accessed by the machine causes the machine to perform operations comprising opening two transmission windows at the source comprises the machine accessible medium including content that when accessed by the machine causes the machine to perform operations comprising opening a first Pre-fetch Control Protocol (PCP) window for the transmission to the destination and opening a second PCP window for the transmission to the alternate node.

15. The article of manufacture of claim 10, wherein the machine accessible medium including content that when accessed by the machine causes the machine to perform operations comprising transmitting a number of packets of a data transmission from the source to the destination via the first path while transmitting the remaining packets of the data transmission from the source to the alternate node via the alternate path comprises the machine accessible medium including content that when accessed by the machine causes the machine to perform operations comprising opening two transmission windows at the alternate node.

16. The article of manufacture of claim 10, wherein the machine accessible medium including content that when accessed by the machine causes the machine to perform operations comprising transmitting a number of packets of a data transmission from the source to the destination via the first path while transmitting the remaining packets of the data transmission from the source to the alternate node via the alternate path comprises the machine accessible medium including content that when accessed by the machine causes the machine to perform operations comprising opening one transmission window at the alternate node.

17. The article of manufacture of claim 10, wherein the machine accessible medium including content that when accessed by the machine causes the machine to perform operations comprising transmitting a number of packets of a data transmission from the source to the destination via the first path while transmitting the remaining packets of the data transmission from the source to the alternate node via the alternate path comprises the machine accessible medium including content that when accessed by the machine causes the machine to perform operations comprising opening two transmission windows at the destination.

18. The article of manufacture of claim 17, wherein the machine accessible medium including content that when accessed by the machine causes the machine to perform operations comprising opening two transmission windows at the destination comprises the machine accessible medium including content that when accessed by the machine causes the machine to perform operations comprising opening a first window for the transmission from the source and opening a second window for the transmission from the alternate node.

19. A system comprising:
a processor;
a network interface coupled to the processor; and
a machine accessible medium including data that when accessed by the processor causes the processor to perform operations comprising:
dividing a data transmission into a plurality of packets at a source;
transmitting a number of the packets of the data transmission from the source to a destination while transmitting the remaining packets of the data transmission from the source to an alternate node; and
transmitting to the destination the packets received at the alternate node from the source.

20. The system of claim 19, wherein the machine-accessible medium including data that causes the processor to perform operations comprising transmitting a number of the packets from the source to a destination while transmitting the remaining packets from the source to an alternate node comprises the machine-accessible medium including data that causes the processor to perform operations comprising transmitting a number of the packets from the source to the destination via one path while transmitting the remaining packets from the source to the alternate node via another path.

21. The system of claim 19, wherein the machine-accessible medium further includes data that causes the processor to perform operations comprising opening two transmission windows at the source.

22. The system of claim 19, wherein the machine-accessible medium further includes data that causes the processor to perform operations comprising opening two transmission windows at the destination.

23. The system of claim 19, wherein the machine-accessible medium further includes data that causes the processor to perform operations comprising opening one transmission window at the alternate node.

24. The system of claim 19, wherein the machine-accessible medium further includes data that causes the processor to perform operations comprising opening two transmission windows at the alternate node.

25. The system of claim 19, wherein the machine-accessible medium further includes data that causes the processor to perform operations comprising assembling and reordering the packets of the data transmission at the destination.
